(19) United States
(12) Patent Application Publication
(10) Pub. No.: US 2007/0155368 A1
(43) Pub. Date: Jul. 5, 2007

(54) Method of updating software code or operating parameters in telematic devices

(75) Inventor: James Daniel Phelan, Paoli, PA (US)

Correspondence Address: GENERAL ELECTRIC CO.;GLOBAL PATENT OPERATION, 187 Danbury Road, Suite 204, Wilton, CT, 06897-4122, US

(73) Assignee: General Electric Company

(21) Appl. No.: 11/323,750

(22) Filed: Dec. 30, 2005

(51) Int. Cl. H04L 12/58

(52) U.S. Cl. 455/412.1

(57) ABSTRACT

A system and method for updating software code or operating parameters on a remote telematics device using a first communications mode and a second broadcast communications mode and a geo-location device.

### FIELD OF THE INVENTION

The present invention relates to a system and method for updating software code or operating parameters in remote telematic devices.

### BACKGROUND OF THE INVENTION

The use of telematics devices on assets to track the assets is common among companies that have a fleet of vehicles. Typically, each telematics device includes a locating unit that can determine the location of the asset, and also a communications system that allows the telematics unit to wirelessly transmit the location of the asset to a central station. The communications system used in telematics devices is typically either satellite-based or cellular-based. That is, the telematics device communicates with a central station using either a satellite-based transceiver or a cellular communications based transceiver.

There are several drawbacks to the use of satellite-based or cellular communications in a telematics system. First, there is usually a fee charged each time a communication is either sent or received by the telematics device using one of those systems. This quickly becomes very expensive when, for example, the central station sends a message to hundreds or thousands of telematics devices on assets. Another drawback to the use of satellite or cellular systems is that the reception of these modes of communication can be less than ideal in certain areas. For example, cellular communications can be very limited in rural areas. The reception of these modes can also be limited in urban areas, such as in urban canyons in a city with tall, closely-spaced buildings. One other drawback to these modes of communications is that they are of a limited bandwidth. It takes a relatively long time to transmit large amounts of information using one of these modes, and that time results in increased communications fees.

The drawbacks associated with satellite and cellular communications become particularly pronounced when large amounts of data are required to be sent to a large number of remote telematics devices. This situation occurs when either software code updates or operating parameter updates are required to be sent to all or a large number of the remote telematics devices in a fleet. Software code and operating parameter updates typically involve a large amount of data.

Several solutions to the problem of communications between a central station and remote telematics units have been disclosed in references. U.S. Pat. No. 5,765,112 and U.S. Pat. No. 5,734,963, disclose the use of radio base station sites to receive information that is transmitted from remote telematics units. These references do not disclose a system for sending data to telematics devices using a broadcast. U.S. Pat. No. 6,892,131 and U.S. Pat. No. 6,611,755 disclose using an FM subcarrier broadcast to transmit Time Division Multiple Access (TDMA) protocol timing information to telematics devices so that a plurality of telematics devices can send data back to a central station using a single communications channel. These references disclose that other limited length messages, such as text messages, predefined messages, or a short user data packet, may be transmitted to a telematics device by using an FM subcarrier broadcast, however, neither reference discloses using an FM subcarrier broadcast to actually update the operating software code on the telematics devices or the operating parameters of the telematics devices.

Accordingly, there is a need in the art for an improved method and system for updating the software code and operating parameters on remote telematics devices.

### BRIEF DESCRIPTION OF THE INVENTION

Accordingly, the present invention is directed to a method of updating software code or operating parameters in telematics devices that substantially obviates one or more of the problems due to limitations and disadvantages of the related art. The present invention provides a method for updating software code or operating parameters in telematics devices on assets using a geo-location device on the asset and two communications modes.

In an illustrative implementation of the present invention, a central station notifies a remote telematics device via a first communications mode when a software code update is available for the telematics device. The location of the telematics device is determined using a geo-location device that is part of the telematics device. If the location of the telematics device is within the coverage area of a broadcast made via a second communications mode, the telematics unit enables a communication device to receive broadcast signals via the second communications mode. The telematics device also sends a message to the central station notifying the central station that the telematics device is in a location where it can receive a software code update via a second communications mode. The central station causes the broadcast of a software code update via a second communications mode in the area where the telematics device is located. The telematics device receives the broadcast update via the second communications mode, and the software code stored in the telematics device is updated. On complete receipt of the update by the telematics device and updating of the software code on the telematics device, the telematics device notifies the central station that the update was completed. The central station then causes the broadcasting of the software code update to stop. If the telematics unit has not successfully updated the software code within a preset time after sending the request to the central station, the telematics unit sends a message to the central station that the software code was not successfully updated.

In another illustrative implementation of the present invention, the location of a remote telematics device is periodically determined using a geo-location device that is part of the telematics device. If the location of the telematics device is within the coverage area of a broadcast made via a second communications mode, the telematics unit sends a message to the central station inquiring whether a software code update is available. If a software code update is available, the central station notifies the telematics device that a software code update is available, and the central station causes the software code update to be broadcast via the second communications mode in the area where the telematics device is located. The update is received by the telematics device and the software code on the telematics unit is updated. On completion of the update, the telematics unit notifies the central station that the update was successfully completed. The central station then causes the broadcast of the software code update to be stopped. If the telematics device has not successfully updated the software code within a preset time after it sent a message asking if a software code update is available, the telematics device sends a message to the central station that the software code was not successfully updated.

In another illustrative implementation, updates of operating parameters for telematics devices are made according to methods described above for updating software code on telemetics units.

Additional features and advantages of the invention will be set forth in the description which follows, and in part will be apparent from the description, or may be learned by practice of the invention. Other advantages of the invention will be realized and attained by the structure particularly pointed out in the written description and claims hereof as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention. In the drawings:

FIG. 1 shows a block diagram of a method of providing a software code update or an operating parameter update to a telematics device where the telematics device is notified of the availability of the update by a central station.

FIG. 2 shows a block diagram of a method of providing a software code update or operating parameters update to a telematics device where the telematics device inquires about the availability of an update.

FIG. 3 shows a block diagram of part of a system in accordance with an embodiment of the method of the invention.

FIG. 4 shows part of a system in accordance with an embodiment of the method of the invention.

### DETAILED DESCRIPTION OF THE INVENTION

Reference will now be made in detail to illustrative examples of the present invention, example of which is illustrated in the accompanying drawings.

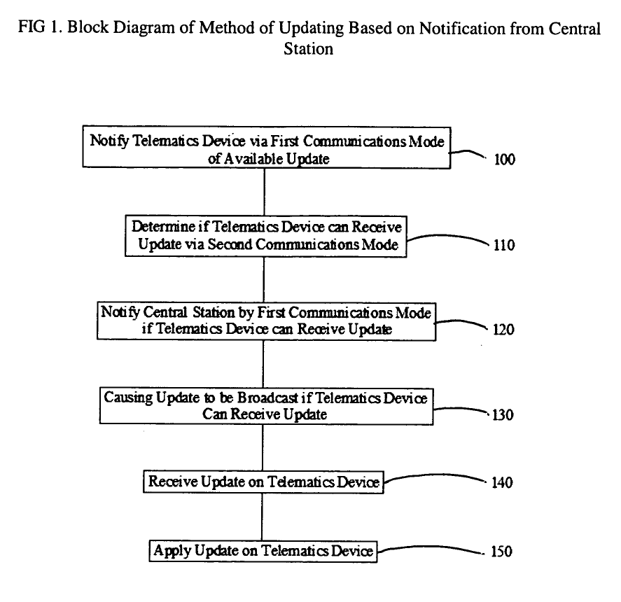

FIG. 1 shows a block diagram of a method of providing an update of software code or operating parameters to a telematics device. A first communications mode is used by a central station to send a notification to a remote telematics device 100 indicating that a software code or operating parameter update is available for the telematics device. The first communications mode can be any type of wireless, bi-directional mode that can be used by the telematics device to both receive and send messages. Examples of such first communications modes includes, but is not limited to, satellite communications and cellular mobile communications modes. The telematics device will include the appropriate transceiver and programming that will allow it to transmit and receive in the first communications mode.

A software code update includes information to update the software code already on the telematics device. The software code being updated can be the entire software code on the telematics device, which controls all aspects of operation of the telematics device, or it can be a limited portion of the software code that is directed to a specific function, similar to the type of software updates performed on any computer system.

The operating parameters of the telematics device can include the parameters that direct what and how often the telematics device performs certain function. For example, one operating parameter of the telematics device can be how often a locating device on the telematics device determines where the telematics device is located, and another operating parameter can be how often the telematics device sends that information back to a central station. If there are sensors, including but not limited to speed, temperature, or contents sensors, that are connected to the telematics device, the operating parameters may direct how often those sensors should make sensor readings. In another embodiment, updating the operating parameters of a telematics device can include directing the telematics device to use a certain set of operating parameters that are already stored on in the memory of the telematics device, where a plurality of sets of operating parameters are stored in the memory of the telematics device.

Upon receiving a message alert that an update is available, the telematics device determines whether it is in an area in which it can receive a broadcast update via a second communications mode 110. The second communications mode is a broadcast mode, such as frequency modulated (FM) broadcast, and the telematics device has a communications system and programming that allows it to receive a broadcast in the second communications mode, if the telematics device is within range of a transmitter that is broadcasting the update. The second broadcast mode can also be an FM subcarrier broadcast mode, in which the update is a digital subcarrier signal that is added to an FM signal.

The telematics device can determine whether it is in an area in which it is able to receive a broadcast update in any number of ways. In one embodiment, the telematics device makes the determination by comparing its current location (which it determines with a geo-location device that is part of, or otherwise linked to, the telematics device) with known areas where broadcast updates can be received. The known areas would be pre-determined areas stored in the memory of the telematics device that define areas (which may be defined as virtual or geo-fences) where it is known that a telematics device would be able to receive the broadcast. Each known area can be associated with a specific broadcast frequency at which the communications device on the telematics device should receive the update. In one embodiment, this frequency information is not necessary if the updates are always broadcast on the same broadcast frequency. However, if the broadcasts are broadcast on different frequencies in different areas, the frequency information can be included with the area information, or the initial message from the central station indicating that an update is available, or in a separate message from the central station to the telematics device, and the telematics device would set the communications system to receive broadcasts at the appropriate frequency when the device is being set to receive an update.

In another embodiment, the telematics device can determine whether it is in an area in which it can receive an update by checking the signal strength of the frequency on which the update is expected to be broadcast. If the system is configured so that updates are always broadcast at a specific frequency regardless of the area in which the telematics device is located, the communications device in the telematics unit can be set to this frequency and the telematics device would check the signal strength of this frequency. In another embodiment where the frequency of the broadcast varies by area, information concerning the frequency to be used in each area can be stored in the memory of the telematics device, and the telematics device would set the communications system to receive broadcasts at the appropriate frequency when the device is being set to receive an update.

If the telematics device determines that it is in a location where it is able to receive a broadcast of an update, it notifies the central station via the first communications mode that the telematics device is able to receive a broadcast of the software code or operating parameter update 120. In one embodiment, the telematics device may then need to activate the second communications mode so that it may receive a broadcast update, in configurations where the second communications mode is not always on. This configuration can occur when the telematics device has (or is linked to) a single communications device that operates in either a first communications mode or a second communications mode, but not at the same time. In this configuration the telematics device directs the communications device to switch to the second communications mode after it notifies the central station via the first communications mode that it is in an area where it can receive a broadcast, so that the telematics device will be able to receive the broadcast. This configuration is advantageous because it reduces the amount of equipment needed in the telematics device, which also reduces the energy needs of the telematics device. This configuration is particularly advantageous on existing telematics devices that use a first communications mode that includes FM band communications, such as an ORBCOMM satellite mode that includes an FM band, as it allows a second communications mode to be implemented without the need for additional equipment, where the second communications mode provides a very cost-effective method to update the software code or operating parameters on the communications device.

In another embodiment, the first communications mode and second communications mode are implemented by separate communications equipment on (or connected to) the telematics device. Such a communications system can be operated in any number of ways, including with both communications modes always on, or with only one communications mode on at any given time. In configurations where only one communications mode is on at any given time, the telematics device will have to switch the between communications modes as needed. In configurations where both communications modes are on all the time, activation of the second communications mode to receive a broadcast update is not needed.

After the telematics device has notified the central station that it is able to receive a broadcast of a software code or operating parameter update, the central station causes an update to be broadcast 130. As will be understood by one with ordinary skill in the art, prior arrangements will have to be made with various broadcasting stations to allow for digital subcarrier signals to be placed on their broadcast signal. A protocol for the software code or operating parameter updates to be transmitted or sent to the broadcast station will have to be implemented as well, and a protocol for how the central station causes the update to be broadcast will have to be arranged between the central station and the broadcast station. In one embodiment, the central station can have web-based access to the broadcast station through software which may also allow the central station to upload updates to the broadcast station and then cause the broadcast station to broadcast those updates. In another embodiment, physical copies of the updates can be sent to the broadcasting station by the central station, and the central station can cause the updates to be transmitted by calling the broadcasting station and directing it to include the update in its signal. Any appropriate protocol can be established that will enable the central station to cause a broadcast of operating software code updates or operating updates to be transmitted by an FM transmitter.

The telematics device receives the update via the second communications mode on the telematics device 140. For example, if the software code update is broadcast as a digital FM subcarrier signal on an FM frequency, the second communications mode on the telematics device is an FM receiver that is capable of receiving the digital FM subcarrier signal. In one embodiment, the update is saved into memory on the telematics device as it is received. Upon complete receipt of the update, which can be determined using appropriate communications protocols to ensure that the entire update has been received, the software code or operating parameters on the telematics device are applied to the telematics device 150.

After the software code update has been successfully received by the telematics device via a second communications mode broadcast, the telematics device can send the central station a message via the first communications mode indicating the receipt of the update. In configurations where the first communications mode and second communications mode are implemented through a single piece of equipment that can only operate in one mode at any given time, the telematics device can be configured to switch the communications device to the first communications mode after successful receipt of the update, so that the telematics device may then send the notification of receipt of the update. In configurations where the first communications mode and second communications mode are implemented through separate equipment that can operate in both modes at the same, such switching may not be necessary.

Upon receipt of notice that the update was successfully received by the telematics device, the central station may cause the broadcast of the software code update to stop. As with the step of causing the update to start to be broadcast, the mechanics of this step depend on the protocol established between the broadcast station and the central station. The protocol may allow the broadcast to be stopped through a web-based application, or the protocol may require a different type of action (such as a phone call from the central station to the broadcast station) to cause the broadcast of the update to be stopped.

The method of the present invention may also provide for the telematics device to send the central station via the first communications mode a notification if an update was not successfully received. In one embodiment, if the asset has not received software code or operating parameter updates within a predetermined period of time from the determination that the asset was within an area able to receive a broadcast update, the asset sends a message to the central system using the first communications mode to indicate the update had not occurred. In another embodiment, If the asset has not moved within a geo-fence within a predetermined length of time, the asset sends a message to the central system using the first communications mode to indicate that the asset has not been within a geo-fence.

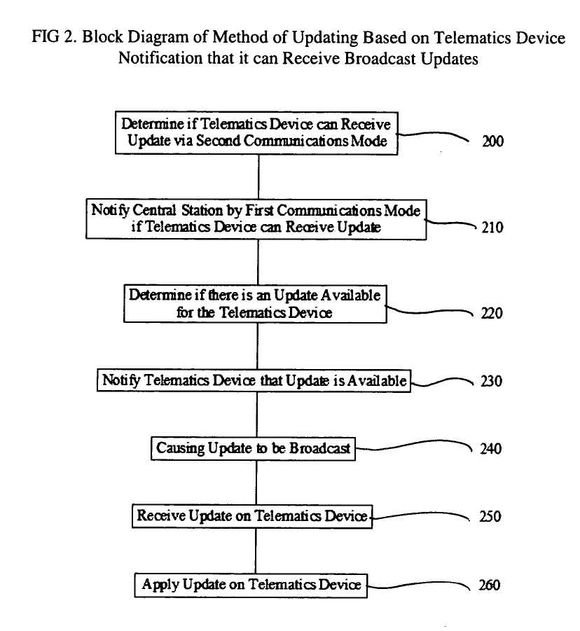

In another embodiment of the method of the present invention shown in FIG. 2, the telematics device checks on its own for available updates, upon entry into an area where it can receive a broadcast update. This embodiment primarily differs from the embodiment of FIG. 1 in that the telematics device looks for an update based on its location, not based upon an alert message received from the central station.

In the first step of the method shown in FIG. 2, the telematics device determines if it is in an area in which it can receive a broadcast update of software code or operating parameters 200. As noted earlier, the telematics device can do this by comparing its present location with areas stored on the telematics device, or it can do this by other means such as by checking the strength of the signal it is receiving on the frequency on which the update would be broadcast.

If the telematics device determines that it is in an area in which it can receive a software code or operating parameter update via broadcast, it notifies the central station via a first communications mode that it can receive a broadcast 210. The central station then determines if there is an update that can be broadcast for the telematics device 220. The central station can make this determination in a number of ways. In one embodiment, the central station has a record of the last software code update or operating parameter update that was sent to the telematics device. The central station can compare this information to the available updates to determine if the telematics device has the latest updates. If the telematics device does not have the latest updates, the central station determines that there is an update available for the telematics device. In another embodiment, the telematics device is configured to send the central station via the first communications mode the version number of the software code or operating parameters that are currently on the telematics device. This can be done in a separate message, or it can be in the initial message sent by the telematics device to the central station in which the telematics device notifies the central station that the telematics device is in an area in which it can receive a broadcast update. After the central station receives this information, it can compare this information to the available updates to determine if the telematics device has the latest updates.

If the central station determines that there is a software code or operating parameter update for the telematics device, the central station notifies the telematics device via the first communications mode that an update is available 230. The central station then causes the update to be broadcast via a second communications mode 240, in the manner described above in relation to the method shown in FIG. 1. The telematics device then receives the update 250 and applies the software code or operating parameters update 260, as also described above in relation to the method shown in FIG. 1. In one embodiment, the telematics device may then notify the central station via the first communications mode that the update was successful.

The method of FIG. 2 may, like the method of FIG. 1, include other additional steps depending on the configuration of the communications system and the first communications mode and second communications mode. In configurations where only one communications mode on the telematics device can be used at any given time, the telematics device will have to switch the between communications modes as needed. In this configuration, the communications system can be switched to the second communications mode after it has sent notification to the central station via the first communications mode that it can receive an update. Then, the communications system can be switched back to the first communications mode after the telematics device has received the update via the second communications mode.

Importantly, the methods shown in FIG. 1 and FIG. 2 are equally applicable to systems having a plurality of telematics devices that need software code or operating parameter upgrades. In systems having a plurality of telematics devices, it may be desirable for each telematics device to have its own unique identifier, which it transmits to the central station each time it communicates with it. This allows the central station to keep track of which telematics devices can receive or have received their updates, and allows the central station to direct communications to a specific telematics device. In addition, in systems having telematics devices that are widely disbursed, the central station may need to be able to cause more than one broadcast station to transmit the software code or operating parameter updates, so that telematics devices that are within the range of different broadcast stations may receive updates.

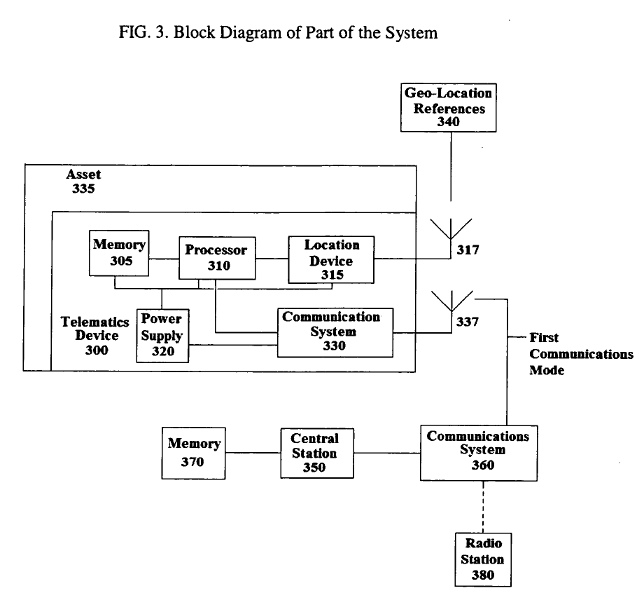

FIG. 3 illustrates a block diagram of a representative system for updating the software code or operating parameters on a telematics device. The system includes an asset 335 containing a telematics device 300. Telematics device 300 may include the following components: a power supply 320, a geo-location device 315, communications system 330, processor 310 and a memory 305, where each of the components is linked to the power supply, or contains its own power supply when modular components are used. Geo-location device 315 is connected to antennae 317 to receive signals from geo-location references 340, such as satellites. Communications system 330 is connected to antennae 337 to communicate through a communications system 360 via a first communications mode to the central station 350 which is linked to memory 370, which may contain information such as software operating code and operating parameter updates, as well as information concerning a plurality of telematics devices such as a unique identifier for each device, the version of the software code or operating parameters on each device, and tracking information received from each device.

Asset 335 can represent a vehicle, trailer, or other piece of equipment for which a position is to be monitored. Telematics device 300 may be single unit which contains all of the components, or individual components, or groups of components, linked together. Power supply 320 may include fuel cells, dry cells, or other types of battery, and may include a solar cell or other energy harvesting device and associated hardware and or software for recharge of the battery. Power supply 320 can also include voltage and/or current regulatory circuitry to supply power to other components in telematics device 300. When telematics device 300 contains an individual component, that component may contain its own power source or be linked to power supply 320.

Location device 315 is a position determining system, such as the Global Positioning System (GPS), Differential GPS (DGPS), Eurofix DGPS, and the Global Navigation Satellite System (GLONASS). Importantly, the present invention is well-suited to use any position determining system (both terrestrial and satellite based) as well as future systems that may be developed, and is not dependent on the use of a particular system. Geo-location device 315 can receive signals from external geo-location references 340, such as satellites, through antennae 317. In one embodiment, geo-location device 315 is part of, or integrated with, the transceiver or receiver of the communications system 330, although geo-location device 315 can also be a separate device specifically for determining the location of the asset 335, or can be a receiver integrated within the telematics device 300. The antenna 317 for the geo-location device 315 may be integrated into the geo-location device 315 or it can be a separate component linked to geo-location device 315 either directly or through linkages in the telematics device 300. In one embodiment, the position of the vehicle can be determined using another type of locating system, such as a system of terrestrial towers that transmit signals to and/or receive signals from a receiver/transmitter located in or on the vehicle. Such a system can use propagation times between the vehicle and the terrestrial towers to triangulate the vehicle's position. This type of triangulation system can be implemented, for example, using a cellular telecommunication infrastructure.

Processor 310 can be part of an embedded device (e.g., an onboard computer with limited functionality) or can be a general use processor that is part of the asset 335. The processor 310 is linked to power supply 320, geo-location device 315, communications system 330 and memory 305. Memory 305 may be any device, including magnetic, optical or solid-state memory, where information stored in the device may be changed by the user. Memory 305 can be used to store the operating software code for the telematics device, which directs the operations of the telematics device including how often the locating device determines the location of the telematics device; when the telematics device communicates with the central station via a first communications mode; when the telematics device activates the second communications mode so that the telematics device may receive software code updates or operating parameter updates; and the protocol to be used in the first and second communications modes. Memory 305 can also be used to store the geographic position of areas where the telematics device may receive broadcast updates, which may be stored in the form of virtual or geo-fences. In addition, memory 305 can store operating parameters or sets of operating parameters that are used to control the functioning of the telematics device.

Communications system 330 is a two mode wireless system located on the asset which is linked to processor 310. The first communications mode of the communications system 330 allows two-way communications between the telematics device 300 on the asset and a central station 350. That two-way communications may be through communications system 360 at the central station 350. The antenna 337 for the first communications mode for communications system 330 may be integrated into the communications system 330 or be a separate component which is linked to communications system 360 either directly or through linkages in the telematics device 300. Communication system 360 for the first communications mode can be a public or private wireless network that allows two way communications between the communications system 330 in telematics device 300 on the asset 335 and central station 350. Communications system 360 and communications system 330 are compatible and use a compatible protocol for transferring messages, data, operating parameters, software updates, or any other information between central station 350 and processor 310 on asset 335.

The second communications mode on the telematics device is a one-way wireless mode that allows the telematics device to receive broadcast signals from a broadcast transmitter. The communications system 330 includes a broadcast receiver (such as an FM receiver) for receiving communications via a second communications mode. The broadcast receiver may be a separate component of the communications system 330, or the broadcast receiver may be integrated with the equipment for the first communications mode, if the equipment for the first mode uses compatible circuitry. For example, certain satellite communications modems that can be used for a first communications mode include FM circuitry. That FM circuitry can be used to implement a second communications mode that allows the telematics device to receive broadcast communications. The antenna for the second communications mode for communications system 330 may be integrated into the communications system 330 or be a separate component which is linked to communications system 330 either directly or through connections in the telematics device 300.

Telematics device 300 is may be a single unit that contains the memory, processor, geo-location device, power supply, and communications device, or telematics device may be multiple units with those capabilities that are linked together. The telematics device operates according to its operating software, and the operating software code is stored in memory 305. The basic operating software controls the various parts of the telematics device, controls the communications between the various parts of the telematics device, and controls the use of the communications device to communicate in a first communications mode or second communications mode. Memory 305 may also include operating parameters or sets of operating parameters that direct the telematics device to perform specific tasks. Operating parameters include parameters such as the frequency of determining the location the asset and the frequency of transmitting the information via the first communications mode to the central station and the frequency with which sensors on the asset (such as speed, temperature, and motion sensors on the asset, not shown) that are connected to the telematics device should make sensor readings and the frequency of transmitting the sensor reading information via the first communications mode to the central station.

Central station 350 can be any facility capable of two way communications via a first communications mode with communications system 330 in telematics device 300 on the asset 335. Communications system 360 at the central station will have appropriate equipment, such as cellular or satellite communications equipment, to allow the central station to communicate with assets via a first communications mode. In addition, communications system 360 may also include communications equipment to allow the central station to communicate with a broadcast station. Such communications equipment can include modems, telephones, or connections to the internet and a web-based interface to the broadcast station, depending on the protocol established for the central station to cause a broadcast station to broadcast an update. The central station may also include a computer, server, and memory (not shown), which are linked to the communications system 360 and which the central station can use to receive and send updates or information to and from telematics devices, to store updates or information, to create software code or operating parameter updates, or to process information from telematics devices.

Geo-location references 340 used will depend upon the geo-location device 315 used. If a GPS receiver is used as the geo-location device 315, the geo-location references 340 will comprise a portion of the set of GPS (also known as NAVSTAR) satellites. In other types of geo-location systems, geo-location references 340 could be cellular communication towers, or other locations/system which provide reference points used by geo-location device 315.

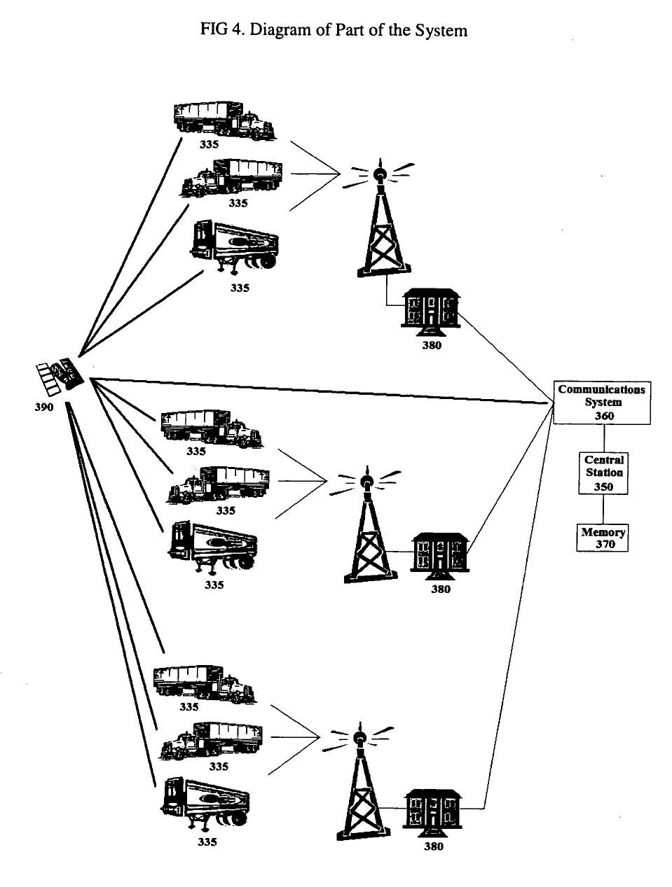

FIG. 4 illustrates the relationship between the central station 350 and the broadcast stations 380 that broadcast updates to assets 335. FIG. 4 also shows a first communications mode using a satellite 390 that allows bidirectional communications between the central station and the assets. Specifically, FIG. 4 illustrates a system in which assets 335 are widely disbursed in different areas such that all of the assets are not in range of a single broadcast station 380. Where such assets 335 have confirmed that they are in areas where they can receive broadcast updates via a second communications mode, the central station 350 causes the appropriate broadcast station 380 to broadcast updates in the areas in which assets 335 have confirmed that they can receive broadcast updates. As noted, the frequency at which the update is broadcast within an area may differ. Accordingly, where it is known that different broadcast frequencies are used in different broadcast areas, the broadcast receiver is set to the proper frequency to be able to receive the broadcast update. In addition, where a number of assets are receiving updates, a unique identifier may be used to identify each asset so it is known which assets have received an update.

It will be apparent to those skilled in the art that various modifications and variation can be made in method of the present invention without departing from the spirit or scope of the invention. Thus, it is intended that the present invention cover the modifications and variations of this invention provided they come within the scope of the appended claims and their equivalents.

What is claimed is:

1. A method for wirelessly updating the software code stored in the memory of a remote telematics device comprising:
notifying the telematics device of the availability of a software code update via a first communications mode;
determining if the telematics device is located in an area able to receive a broadcast of the software code update via a second communications mode;
notifying a central station via the first communications mode whether the telematics device is able to receive a broadcast of the software code update; and
if the telematics device is located in an area able to receive a broadcast of the software code update:
causing a software code update to be broadcast that is capable of being received by the second communications mode on the telematics device;
receiving the software code update at the telematics device via the second communications mode; and
updating the software code stored in the memory of the telematics device with the software code update.

2. The method of claim 1, wherein the first communications mode is a wireless communications mode selected from the group of satellite communications and cellular communications, and wherein notifying the telematics device comprises transmitting an update alert from a central station to the telematics device via the first communications mode.

3. The method of claim 1, wherein determining if the telematics device is located in an area able to receive a broadcast of the software code update comprises determining the present location of the asset with a locating device on the asset and comparing the location of the asset with predetermined areas stored in the memory on the asset that are areas where a broadcast of a software code update can be received.

4. The method of claim 1, further comprising, if the telematics device is located in an area able to receive a broadcast of the software code update, activating the second communications mode on the telematics device before the software code update is caused to be broadcast and de-activating the second communications mode on the telematics device after receipt of the software code update by the telematics device.

5. The method of claim 1, further comprising dynamically switching a communications system on the telematics device from the first communications mode to the second communications mode if the telematics device is located in an area able to receive a broadcast of the software code update, and dynamically switching the telematics device from the second communications mode to the first communications mode after receipt of the software code update by the telematics device.

6. The method of claim 1, wherein the second communications mode is FM communications and wherein broadcasting the software code update comprises causing the software code update to be transmitted on an FM subcarrier frequency.

7. The method of claim 1, further comprising notifying a central station via the first communications mode that the software code update has been received by the telematics device after the software code update is received by the telematics device.

8. The method of claim 7, further comprising causing the broadcasting of the software code update to stop after receipt by the central station of notification that the software code update has been received by the telematics device.

9. The method of claim 1, further comprising notifying the central station via the first communications mode that the software code update has not been received by the telematics device if the software code update is not received by the telematics device within a predetermined time after the telematics device has notified the central station that it is able to receive a broadcast update.

10. A method for wirelessly updating the software code stored in the memory of a remote telematics device comprising:
determining if the telematics device is located in an area able to receive a broadcast of the software code update;
notifying a central station via the first communications mode that the telematics device is able to receive a broadcast of the software code update;
determining if there is a software code update for the telematics device; and
if there is a software code update for the telematics device:
notifying the telematics device of a software code update;
causing a software code update to be broadcast that is capable of being received by the second communications mode on the telematics device;
receiving the software code update at the telematics device via the second communications mode; and
updating the software code stored in the memory of the telematics device with the software code update.

11. The method of claim 10, wherein the first communications mode is a wireless communications mode selected from the group of satellite communications and cellular communications, and wherein notifying the telematics device comprises transmitting an update alert from a central station to the telematics device via the first communications mode.

12. The method of claim 10, wherein determining if the telematics device is located in an area able to receive a broadcast of the software code update comprises determining the present location of the asset with a locating device on the asset and comparing the location of the asset with predetermined areas stored in the memory on the asset that are areas where a broadcast of a software code update can be received.

13. The method of claim 10, further comprising, if there is a software code update for the telematics device, activating the second communications mode on the telematics device before the software code update is caused to be broadcast and de-activating the second communications mode on the telematics device after receipt of the software code update by the telematics device.

14. The method of claim 10, further comprising dynamically switching a communications system on the telematics device from the first communications mode to the second communications mode if there is a software code update for the telematics device, and dynamically switching the telematics device from the second communications mode to the first communications mode after receipt of the software code update by the telematics device.

15. The method of claim 10, wherein the second communications mode is FM communications and wherein broadcasting the software code update comprises causing the software code update to be transmitted on an FM subcarrier frequency.

16. The method of claim 10, further comprising notifying a central station via the first communications mode that the software code update has been received by the telematics device after the software code update is received by the telematics device.

17. The method of claim 16, further comprising causing the broadcasting of the software code update to stop upon receipt by the central station of notification that the software code update has been received by the telematics device.

18. The method of claim 10 further comprising notifying the central station via the first communications mode that the software code update has not been received by the telematics device if the software code update is not received by the telematics device within a predetermined time after the telematics device has notified the central station that it is able to receive a broadcast update.

19. A method for wirelessly updating the operating parameters stored in the memory of a remote telematics device comprising:
notifying the telematics device of an operating parameters update via a first communications mode;
determining if the telematics device is located in an area able to receive a broadcast of the operating parameters update;
notifying a central station via the first communications mode whether the telematics device is able to receive a broadcast of the operating parameters update; and
if the telematics device is located in an area able to receive a broadcast of the operating parameters update:
causing an operating parameters update to be broadcast that is capable of being received by the second communications mode on the telematics device;
receiving the operating parameters update at the telematics device via the second communications mode; and
updating the operating parameters stored in the memory of the telematics device with the operating parameters update.

20. The method of claim 19, wherein the first communications mode is selected from the group of satellite communications and cellular communications, and wherein notifying the telematics device comprises transmitting an update alert from a central station to the telematics device via the first communications mode.

21. The method of claim 19, wherein determining if the telematics device is located in an area able to receive a broadcast of the software code update comprises determining the present location of the asset with a locating device on the asset and comparing the location of the asset with predetermined areas stored in the memory on the asset that are areas where a broadcast of a software code update can be received.

22. The method of claim 19, further comprising, if the telematics device is located in an area able to receive a broadcast of the operating parameters update, activating the second communications mode on the telematics device before the operating parameters update is caused to be broadcast and de-activating the second communications mode on the telematics device after receipt of the operating parameters update by the telematics device.

23. The method of claim 19, further comprising dynamically switching a communications system on the telematics device from the first communications mode to the second communications mode if the telematics device is located in an area able to receive a broadcast of the operating parameters update, and dynamically switching the telematics device from the second communications mode to the first communications mode after receipt of the operating parameters update by the telematics device.

24. The method of claim 19, wherein the second communications mode is FM communications and wherein broadcasting the operating parameters update comprises causing the operating parameters update to be transmitted on an FM subcarrier frequency.

25. The method of claim 19, further comprising notifying a central station via the first communications mode that the operating parameters update has been received by the telematics device after the operating parameters update is received by the telematics device.

26. The method of claim 25, further comprising causing the broadcasting of the operating parameters update to stop upon receipt by the central station of notification that the operating parameters update has been received by the telematics device.

27. The method of claim 19, further comprising notifying the central station via the first communications mode that the operating parameter update has not been received by the telematics device if the operating parameter update is not received by the telematics device within a predetermined time after the telematics device has notified the central station that it is able to receive a broadcast update.

28. A method for wirelessly updating the operating parameters stored in the memory of a remote telematics device comprising:
determining if the telematics device is located in an area able to receive a broadcast of the operating parameters update;
notifying a central station via the first communications mode that the telematics device is able to receive a broadcast of the operating parameters update;
determining if there is an operating parameters update for the telematics device; and
if there is an operating parameters update for the telematics device:
notifying the telematics device of a operating parameters update;
causing a operating parameters update to be broadcast that is capable of being received by the second communications mode on the telematics device;
receiving the operating parameters update at the telematics device via the second communications mode; and
updating the operating parameters stored in the memory of the telematics device with the operating parameters update.

29. The method of claim 28, wherein the first communications mode is selected from the group of satellite communications and cellular communications, and wherein notifying the telematics device comprises transmitting an update alert from a central station to the telematics device via the first communications mode.

30. The method of claim 28, wherein determining if the telematics device is located in an area able to receive a broadcast of the software code update comprises determining the present location of the asset with a locating device on the asset and comparing the location of the asset with predetermined areas stored in the memory on the asset that are areas where a broadcast of a software code update can be received.

31. The method of claim 28, further comprising, if there is an operating parameters update for the telematics device, activating the second communications mode on the telematics device before the operating parameters update is caused to be broadcast and de-activating the second communications mode on the telematics device after receipt of the operating parameters update by the telematics device.

32. The method of claim 28, further comprising dynamically switching a communications system on the telematics device from the first communications mode to the second communications mode if there is an operating parameters update for the telematics device, and dynamically switching the telematics device from the second communications mode to the first communications mode after receipt of the operating parameters update by the telematics device.

33. The method of claim 28, wherein the second communications mode is FM communications and wherein broadcasting the operating parameters update comprises causing the software code update to be transmitted on an FM subcarrier frequency.

34. The method of claim 28, further comprising notifying a central station via the first communications mode that the operating parameters update has been received by the telematics device after the operating parameters update is received by the telematics device.

35. The method of claim 34, further comprising causing the broadcasting of the operating parameters update to stop upon receipt by the central station of notification that the operating parameters update has been received by the telematics device.

36. The method of claim 28, further comprising notifying the central station via the first communications mode that the operating parameter update has not been received by the telematics device if the operating parameter update is not received by the telematics device within a predetermined time after the telematics device has notified the central station that it is able to receive a broadcast update.

37. A system for wirelessly updating the software code stored in the memory of a remote telematics device comprising:
a remote telematics device having a locating device and a communications system having a first communications mode and a second communications mode, wherein the remote telematics device is configured to receive a software code update via the second communications mode if it is in a location in which it is capable of receiving a software code update and to update the software code stored in the memory of the remote telematics device with the software code update; and
a central station having a communications system capable of transmitting and receiving in a first communications mode, and wherein the central station is capable of causing at least one broadcasting station to transmit a software code update via a second communications mode to a telematics device if the central station receives notification from the telematics device via the first communications mode that the telematics device is in a location in which it is capable of receiving a software code update.

38. The system of claim 37, wherein the first communications mode is selected from the group of satellite communications and cellular communications.

39. The system of claim 37, wherein the second communications mode is FM communications and wherein causing a broadcasting station to transmit the software code update comprises causing the software code update to be transmitted on an FM subcarrier frequency.

40. The system of claim 37, wherein the communications system comprises a first communications device for the first communications mode and a second communications device for the second communications mode.

41. The system of claim 37, wherein the communications system comprises a single communications device that is configured to dynamically switch from the first communications mode to the second communications mode to receive a software code update and configured to dynamically switch from the second communications mode to the first communications mode when a software code update is not being received.

42. A system for wirelessly updating the operating parameters stored in the memory of a remote telematics device comprising:
a remote telematics device having a locating device and a communications system having a first communications mode and a second communications mode, wherein the remote telematics device is configured to receive an operating parameters update via the second communications mode if it is in a location in which it is capable of receiving an operating parameters update and to update the operating parameters stored in the memory of the remote telematics device with the operating parameters update; and
a central station having a communications system capable of transmitting and receiving in a first communications mode, and wherein the central station is capable of causing at least one broadcasting station to transmit an operating parameters update via a second communications mode to a telematics device if the central station receives notification from the telematics device via the first communications mode that the telematics device is in a location in which it is capable of receiving an operating parameters update;

43. The system of claim 42, wherein the first communications mode is selected from the group of satellite communications and cellular communications.

44. The system of claim 42, wherein the second communications mode is FM communications and wherein causing a broadcasting station to transmit the operating parameters update comprises causing the operating parameters update to be transmitted on an FM subcarrier frequency.

45. The system of claim 42, wherein the communications system comprises a first communications device for the first communications mode and a second communications device for the second communications mode.

46. The system of claim 42, wherein the communications system comprises a single communications device that is configured to dynamically switch from the first communications mode to the second communications mode to receive an operating parameters update and configured to dynamically switch from the second communications mode to the first communications mode when an operating parameters update is not being received.
